(19) United States
(12) Patent Application Publication
(10) Pub. No.: US 2025/0306905 A1
(43) Pub. Date: Oct. 2, 2025

(54) RESOURCE DOWNLOAD METHOD, APPARATUS, DEVICE, MEDIUM AND PRODUCT

(71) Applicant: Beijing Youzhuju Network Technology Co., Ltd., Beijing (CN)

(72) Inventors: Biyu Guo, Beijing (CN); Shengyan Shi, Beijing (CN); Xiaomin Song, Beijing (CN)

(21) Appl. No.: 19/092,248

(22) Filed: Mar. 27, 2025

(30) Foreign Application Priority Data
Mar. 27, 2024 (CN) 202410362023.0

(51) Int. Cl. G06F 8/65; G06F 3/0483; G06F 3/0484

(52) U.S. Cl. CPC G06F 8/65; G06F 3/0483; G06F 3/0484

(57) ABSTRACT

A resource download method, apparatus, device, medium and product are disclosed in the present application. The method includes: in response to a trigger operation for a resource download control displayed in a video playback page, adding and displaying a download progress description object and a first prompt object in the video playback page, wherein the resource download control is used to trigger a download process of a resource associated with a first video displayed in the video playback page, and the download progress description object is used to describe a download progress of the resource; after switching the first video displayed in the video playback page to a second video, in response to determining that the resource has been completely downloaded, adding and displaying a second prompt object in the video playback page, wherein the second prompt object is used to prompt that the resource has been completely downloaded.

### CROSS-REFERENCE TO RELATED APPLICATION(S)

This application claims priority to Chinese Application No. 202410362023.0 filed on Mar. 27, 2024, the disclosures of which is incorporated herein by reference in its entirety.

### FIELD

The present application relates to the field of computer technology, and more particularly, to a resource download method, apparatus, device, medium and product.

### BACKGROUND

Nowadays, some application scenarios are applied widely, such as live video stream scenarios, short video stream scenarios or other video stream scenarios.

### SUMMARY

The present application provides a resource download method, apparatus, device, medium and product, which can better improve user experience.

In order to achieve the above purpose, the technical solutions provided in this application are as follows:

The present application provides a resource download method, the method including:
in response to a trigger operation for a resource download control displayed in a video playback page, adding and displaying a download progress description object and a first prompt object in the video playback page, wherein the resource download control is used to trigger a download process of a resource associated with a first video displayed in the video playback page, and the download progress description object is used to describe a download progress of the resource, and the first prompt object is used to prompt that switching a video will not interrupt the downloading of the resource;
after switching the first video displayed in the video playback page to a second video, in response to determining that the resource has been completely downloaded, adding and displaying a second prompt object in the video playback page, wherein the second prompt object is used to prompt that the resource has been completely downloaded.

In one possible implementation, the video playback page is used to play part or all of videos in a video stream in sequence, and an arrangement position of the first video in the video stream is adjacent to an arrangement position of the second video in the video stream.

In one possible implementation, the resource comprises an application.

In one possible implementation, a position of the second prompt object in the video playback page and a position of the second video in the video playback page satisfy a preset position constraint, and the preset position constraint is used to ensure that an impact degree of displaying the second prompt object on displaying the second video does not exceed a preset threshold.

In one possible implementation, the first prompt object is displayed by covering the download progress description object; and
after adding and displaying the download progress description object and the first prompt object in the video playback page, the method further includes:
in response to determining that a display duration of the first prompt object reaches a preset duration threshold or a close operation for the first prompt object being triggered, canceling displaying the first prompt object from the video playback page.

In one possible implementation, the display content of the download progress description object includes a pause download identifier; and
after adding and displaying the download progress description object and the first prompt object in the video playback page, the method further includes:
in response to a trigger operation for the download progress description object, canceling displaying the download progress description object from the video playback page, and adding and displaying a continue download control and a cancel download control in the video playback page; and
in response to a trigger operation for the continue download control, canceling displaying the continue download control and the cancel download control from the video playback page, and resuming displaying the download progress description object in the video playback page.

In one possible implementation, after adding and displaying the continue download control and the cancel download control in the video playback page, the method further includes:
in response to a trigger operation for the cancel download control, adding and displaying a cancel confirm object in the video playback page, and the cancel confirm object is used to confirm whether to cancel the downloading of the resource;
in response to a confirm cancel operation triggered for the cancel confirm object, canceling displaying the cancel confirm object from the video playback page, resuming displaying the resource download control in the video playback page, and adding and displaying a third prompt object in the video playback page, and the third prompt object is used to prompt that the downloading of the resource has been cancelled; or
in response to an abort cancel operation triggered for the cancel confirm object, canceling displaying the cancel confirm object, the continue download control and the cancel download control from the video playback page, and resuming displaying the download progress description object in the video playback page.

In one possible implementation, the resource is downloaded in the background in response to the trigger operation for the resource download control.

In one possible implementation, before in response to determining that the resource has been completely downloaded, adding and displaying the second prompt object in the video playback page, the method further includes:
after switching the first video displayed in the video playback page to the second video, adding and displaying a background download confirm object in the video playback page, and the background download confirm object is used to confirm whether to adjust to download the resource in the background; and
in response to a confirm background download operation triggered for the background download confirm object, canceling displaying the background download confirm object from the video playback page.

In one possible implementation, after adding and displaying the background download confirm object in the video playback page, the method further includes:
in response to an abort background download operation triggered for the background download confirm object, canceling displaying the background download confirm object from the video playback page, and adding and displaying a third prompt object in the video playback page, and the third prompt object is used to prompt that the downloading of the resource has been cancelled.

In one possible implementation, the second prompt object includes a resource use control, and the resource use control is used to trigger a use process for the resource that has been downloaded completely; and
after adding and displaying the second prompt object in the video playback page, the method further includes:
in response to a video switch operation triggered for the video playback page, switching the second video displayed in the video playback page to a third video, and keeping displaying the second prompt object in the video playback page; and
in response to a trigger operation for the resource use control, cancelling displaying the second prompt object from the video playback page.

The present application provides a resource download apparatus, including:
a first update unit, configured to, in response to a trigger operation for a resource download control displayed in a video playback page, add and display a download progress description object and a first prompt object in the video playback page, and the resource download control is used to trigger a download process of a resource associated with a first video displayed in the video playback page, and the download progress description object is used to describe a download progress of the resource, and the first prompt object is used to prompt that switching a video will not interrupt the downloading of the resource;
a second update unit, configured to, after switching the first video displayed in the video playback page to a second video, in response to determining that the resource has been completely downloaded, add and display a second prompt object in the video playback page, and the second prompt object is used to prompt that the resource has been completely downloaded.

The present application provides an electronic device, the device including: a processor and a memory;
the memory is configured to store instructions or computer programs;
the processor is configured to execute the instructions or the computer programs in the memory to cause the electronic device to execute the resource download method provided in the present application.

The present application provides a computer-readable medium, where instructions or computer programs are stored in the computer-readable medium, and when the instructions or the computer programs are executed by a device, the device is caused to execute the resource download method provided in the present application.

The present application provides a computer program product, which includes computer programs carried on a non-transitory computer-readable medium, where the computer programs contain program codes for executing the resource download method provided in the present application.

### BRIEF DESCRIPTION OF THE DRAWINGS

In order to more clearly describe the technical solutions in the embodiments of the present application or in the related art, the drawings required in describing the embodiments or the related art will be briefly introduced below. Obviously, the drawings in the following description are only some embodiments recorded in the present application, and those skilled in the art can obtain other drawings according to these drawings without paying creative efforts.

FIG. 1 is a flowchart of a resource download method provided by an embodiment of the present application;

FIG. 2 is a schematic diagram of a resource-related page change process provided by an embodiment of the present application;

FIG. 3 is a schematic diagram of a resource-related page change process provided by an embodiment of the present application;

FIG. 4 is a schematic diagram of a resource-related page change process provided by an embodiment of the present application;

FIG. 5 is a schematic diagram of a resource-related page change process provided by an embodiment of the present application;

FIG. 6 is a schematic diagram of a resource-related page change process provided by an embodiment of the present application;

FIG. 7 is a schematic diagram of a resource-related page change process provided by an embodiment of the present application;

FIG. 8 is a schematic diagram of a resource-related page change process provided by an embodiment of the present application;

FIG. 9 is a schematic diagram of a resource-related page change process provided by an embodiment of the present application;

FIG. 10 is a schematic diagram of a resource-related page change process provided by an embodiment of the present application;

FIG. 11 is a schematic diagram of a resource-related page change process provided by an embodiment of the present application;

FIG. 12 is a schematic diagram of a resource-related page change process provided by an embodiment of the present application;

FIG. 13 is a schematic diagram of a resource download process provided by an embodiment of the present application;

FIG. 14 is a schematic diagram of a structure of a resource download apparatus provided by an embodiment of the present application; and

FIG. 15 is a schematic diagram of a structure of an electronic device provided by an embodiment of the present application.

### DETAILED DESCRIPTION OF EMBODIMENTS

As mentioned above, some application scenarios are applied widely, however, these scenarios have the following requirements: when a certain video in a video stream and a resource associated with the video are displayed on a page, a user can not only watch the video, but also download the resource.

It is found through research that, for some related technical solutions, the solution may specifically be: when a certain video in a video stream and a resource download control corresponding to the video are displayed on a page, if it is detected that the user triggers a click operation on the resource download control, resource download is started, and the user will stay on the first video until the resource download is completed.

It is further found through research that the above related technical solutions have the following defects: (1) the user stays on the first video to wait for the resource to complete downloading, which makes the video viewing rhythm of the user to be interrupted, thus affecting the video viewing experience of the user. (2) When the resource download duration is relatively long, if the user is eager to view a subsequent video, the user will usually choose to interrupt the resource download first and then switch the video, thus affecting the resource download experience of the user.

Based on the above research, in order to better improve user experience, the present application provides a resource download method, the method including: for a video playback page displaying a first video, when the video playback page also displays a resource download control corresponding to the first video, the resource download control is used to trigger a download process of a resource associated with the first video displayed in the video playback page, so that after detecting a trigger operation for the resource download control, a download progress description object and a first prompt object are added and displayed on the video playback page, so that the download progress description object is used to describe a download progress of the resource, and the first prompt object is used to prompt that switching a video will not interrupt the downloading of the resource, so that the user can not only know the download progress of the resource from the video playback page, but also know from the video playback page that switching the video will not interrupt the downloading of the resource, so that the wrong perception of “must stay in the first video during resource download” can be effectively corrected, so that after switching the first video displayed in the video playback page to a second video, in response to determining that the resource has been completely downloaded, a second prompt object is added and displayed on the video playback page, so that the second prompt object is used to prompt that the resource has been completely downloaded, so that it can be realized that the video viewing rhythm of the user is further ensured to be unaffected on the premise of meeting the resource download requirements, thus defects caused by the user staying in the first video to wait for the resource to complete downloading or defects caused by the user choosing to interrupt the resource download due to being eager to view a subsequent video can be effectively avoided, thereby being beneficial to improving user experience, such as video viewing experience and resource download experience.

In addition, the present application does not limit the execution subject of the resource download method provided by the embodiments of the present application. For example, the resource download method provided by the embodiments of the present application may be applied to a terminal device. For another example, the resource download method provided by the embodiments of the present application may also be implemented by means of a data interaction process between a terminal device and a server. The terminal device may be a smart phone, a computer, a personal digital assistant (PDA), a tablet computer, etc. The server may be an independent server, a cluster server or a cloud server.

In order to enable those skilled in the art to better understand the solution of the present application, the technical solutions in the embodiments of the present application will be clearly and completely described below in combination with the drawings in the embodiments of the present application. Obviously, the described embodiments are only a part of the embodiments of the present application, but not all of the embodiments. Based on the embodiments in the present application, all other embodiments obtained by those of ordinary skill in the art without creative efforts fall within the protection scope of the present application.

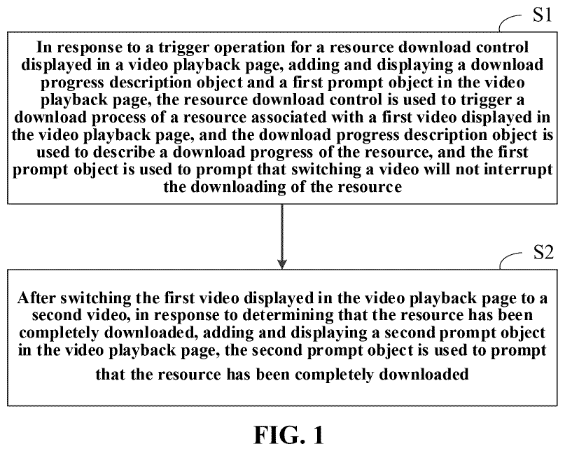

In order to better understand the technical solutions provided by the present application, the resource download method provided by the present application will be described below in combination with some drawings. As shown in FIG. 1, the resource download method provided by the embodiment of the present application includes the following S1-S2. FIG. 1 is a flowchart of a resource download method provided by an embodiment of the present application.

S1: in response to a trigger operation for a resource download control displayed in a video playback page, adding and displaying a download progress description object and a first prompt object in the video playback page, wherein the resource download control is used to trigger a download process of a resource associated with a first video displayed in the video playback page, wherein the download progress description object is used to describe a download progress of the resource, wherein the first prompt object is used to prompt that switching a video will not interrupt the downloading of the resource.

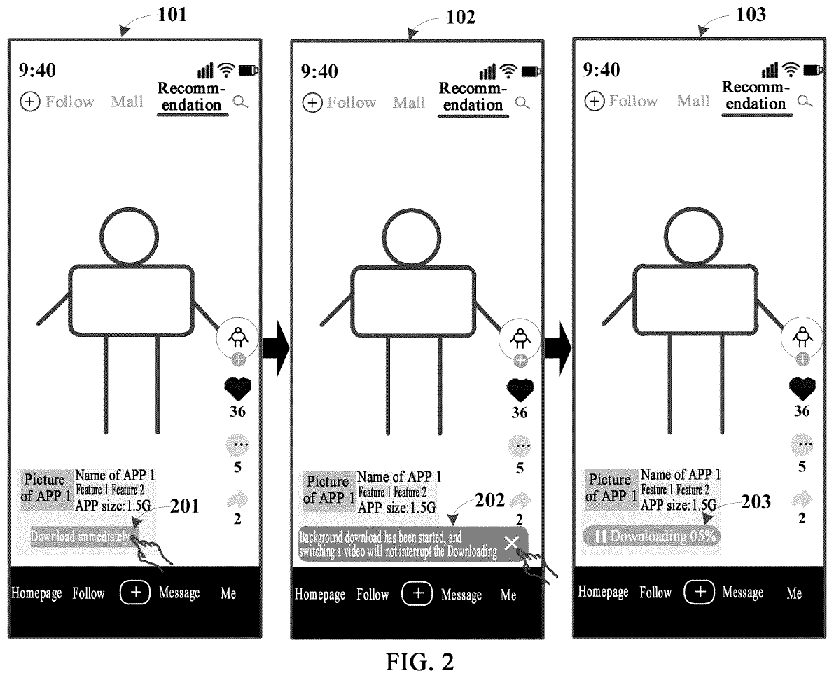

The video playback page is used to play videos. Furthermore, the present application does not limit the implementation of the video playback page. For example, in some application scenarios, such as live video stream scenarios, short video stream scenarios or other video stream scenarios, the video playback page may refer to a video stream playback page corresponding to a certain label, so that the video playback page can be used to play part or all of the videos in the video stream in sequence. The label is used to identify the video stream. Furthermore, the present application does not limit the implementation of the label. For example, the label may be implemented with “Recommendation” in page 101 shown in FIG. 2. The video stream refers to a video sequence, so that the video stream may include some videos arranged in sequence, so that these videos can be played in sequence with the help of the same page. Furthermore, the present application does not limit the acquisition process of the video stream. It can be seen that in a possible implementation, the video playback page may refer to a video stream playback page corresponding to the label “Recommendation”, such as page 101 shown in FIG. 2.

The first video refers to a video displayed on the video playback page at the current time, such as the video displayed by page 101 in FIG. 2. It can be seen that in a possible implementation, when the video playback page is used to play part or all of the videos in the video stream in sequence, the first video refers to a video that exists in the video stream and is played by the video playback page at the current time.

The resource download control refers to a control that is displayed on the video playback page at the current time and is used to trigger a download process of a resource associated with the first video displayed on the video playback page, such as immediate download control 201 shown in FIG. 2. The resource refers to an object that is associated with the first video and can be downloaded. Furthermore, the present application does not limit the implementation of the resource. For example, the resource may be an application, such as application 1 shown in FIG. 2, so that the user can complete the download processing and installation processing for the application with the help of the video playback page. For another example, the resource may be a document, audio, or video, etc., so that the user can complete the download processing and use processing for the resource with the help of the video playback page.

It should be noted that the present application does not limit the association relationship between the resource and the first video in the above paragraph. For example, in some application scenarios, such as scenarios where resources are recommended by means of videos, the resource may refer to an object recommended by the first video, such as applications similar to games, reading, instant messaging, etc. For another example, in some other application scenarios, such as scenarios where resources are introduced by means of videos, the resource may refer to an object described by the first video, such as applications similar to games, reading, instant messaging, etc.

The download progress description object is used to describe the download progress of the resource associated with the first video. Furthermore, the present application does not limit the implementation of the download progress description object. For example, it may be implemented with any object that can represent the resource download progress, such as an interface, a window, a control, text, a progress bar, or a pie chart. It can be seen that in a possible implementation, the download progress description object may be implemented with control 203 shown in FIG. 2, so that the display content of the download progress description object at least includes the download progress of the resource, such as a character string similar to “05%”.

In addition, in some application scenarios, in order to better save page space, the present application further provides a possible implementation of the above download progress description object. In this implementation, the display content of the download progress description object may include a pause download identifier, so that the download progress description object can not only describe the download progress of the resource associated with the first video, but also express to the user that the user can trigger to pause the downloading by means of the download progress description object. The pause download identifier is used to indicate that the download progress description object is configured with a pause download function, so that the user can achieve pausing downloading by triggering the download progress description object. Furthermore, the present application does not limit the implementation of the pause download identifier. For example, it may be implemented with the symbol “∥” displayed on control 203 in FIG. 2. It can be seen that in a possible implementation, the download progress description object may be implemented with control 203 in FIG. 2, so that the download progress description object can not only convey the download progress of the resource to the user, but also convey to the user that the user can implement pausing downloading by means of triggering the download progress description object, thus being able to effectively avoid the user's confusion caused by the lack of a pause download identifier, such as confusion about what operation to perform to pause downloading, so that user experience can be improved without increasing page space consumption.

The first prompt object is used to prompt that switching a video will not interrupt the downloading of the resource associated with the first video, so that the first prompt object can convey to the user that the user can still switch the video during the resource download, without staying on the first video to wait for the resource to be downloaded, so that it can be realized that the video viewing rhythm of the user is further ensured to be unaffected on the premise of meeting the resource download requirements, thus defects caused by the user staying in the first video to wait for the resource to complete downloading or defects caused by the user choosing to interrupt the resource download due to being eager to view a subsequent video can be effectively avoided, thereby being beneficial to improving user experience, such as video viewing experience and resource download experience. Because the first prompt object is displayed in response to the trigger operation for the resource download control, the display moment of the first prompt object is almost close to the trigger moment of the download process of the resource, so that the user can know as early as possible that the user can continue to switch the video during the download of the resource, which can minimize the impact of the resource download on the video viewing rhythm of the user, thus being beneficial to better improving the user experience.

In addition, the present application does not limit the implementation of the first prompt object. For example, it may be implemented with any object that can represent prompt information, such as a prompt box, a control, or a prompt interface. It can be seen that in a possible implementation, the first prompt object may be implemented with prompt box 202 shown in FIG. 2.

In addition, the present application does not limit the relationship between the display position of the first prompt object and the display position of the download progress description object. For example, in some application scenarios, in order to better save page space, the first prompt object may be displayed by covering the download progress description object, and the download progress description object is displayed by occupying the display position of the above resource download control, thus being able to realize increasing the display content of the page without additional space overhead. The display position of the resource download control refers to the position of the resource download control in the video playback page.

Furthermore, in order to be able to better improve user experience, the present application further provides a display mechanism of the first prompt object, which may specifically be: after adding and displaying the download progress description object and the first prompt object on the video playback page, if the first prompt object is displayed by covering the download progress description object, the user can know as early as possible from the video playback page that the user can continue to switch the video during the download of the resource, so that subsequently in response to determining that the display duration of the first prompt object reaches a preset duration threshold or a close operation for the first prompt object being triggered, the first prompt object is cancelled from being displayed on the video playback page, so that the user can know the download progress of the resource from the video playback page, such as page 103 shown in the figure. The preset duration threshold may be set in advance according to the application scenario, for example, the preset duration threshold may be 3 seconds. The close operation is used to trigger a close process for the first prompt object. Furthermore, the present application does not limit the implementation of the close operation. For example, it may refer to a click operation triggered for a close button in the first prompt object. The close button is used to trigger the close process for the first prompt object. Furthermore, the present application does not limit the close button. For example, it may be implemented with the button “×” in prompt box 202 in FIG. 2.

Furthermore, the present application does not limit the implementation of the above S1. For example, in order to better improve user experience, the S1 may specifically be: in response to a trigger operation for a resource download control displayed in a video playback page, canceling displaying the resource download control from the video playback page, and adding and displaying a download progress description object and a first prompt object on the video playback page, so that the download progress description object is displayed by occupying the display position of the resource download control, and the first prompt object is displayed by covering the download progress description object, so that the user can know as early as possible from the video playback page that the user can continue to switch the video during the download of the resource, so that the impact of the resource download on the video viewing rhythm of the user can be minimized, thereby being beneficial to better improving the user experience.

Based on the related content of the above S1, it can be seen that in some application scenarios, such as the scenario shown in FIG. 2, for a video playback page, such as page 101 shown in FIG. 2, when the video playback page is displaying a first video and a resource download control corresponding to the first video, such as immediate download control 201 shown in FIG. 2, after detecting a trigger operation for the resource download control, such as a click operation, the resource download control is cancelled from being displayed on the video playback page, and a download progress description object and a first prompt object are added and displayed on the video playback page, so that the video playback page, such as page 102 shown in FIG. 2, can at least convey to the user that switching the video will not interrupt the downloading of the resource. Because the first prompt object is displayed by covering the download progress description object, the user can know as early as possible from the video playback page that the user can continue to switch the video during the download of the resource, which is beneficial to improving user experience.

S2: after switching the first video displayed on the video playback page to a second video, in response to determining that the resource associated with the first video has been completely downloaded, adding and displaying a second prompt object on the video playback page; the second prompt object is used to prompt that the resource has been completely downloaded.

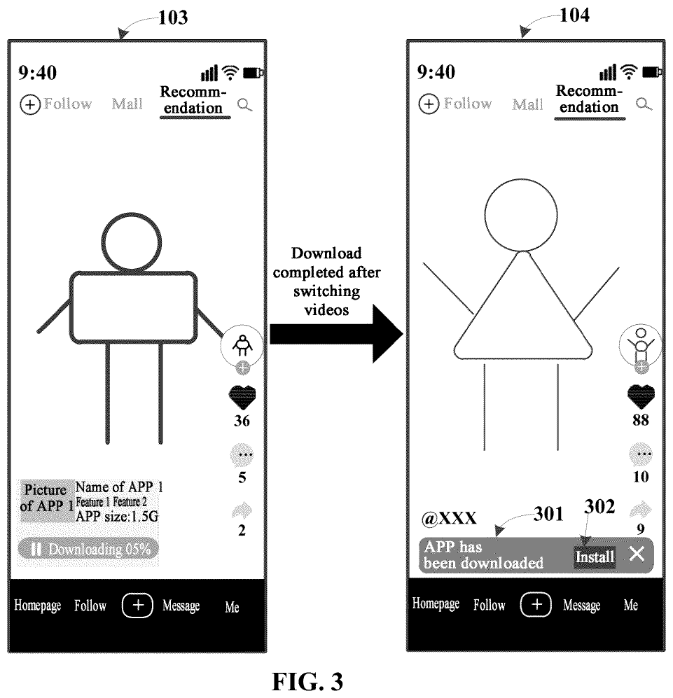

The second video refers to a video to be switched to when switching a video for a video playback page displaying the first video. Furthermore, the present application does not limit the second video. For example, in a possible implementation, when the video playback page is used to play part or all of the videos in the video stream in sequence, the arrangement position of the first video in the video stream is adjacent to the arrangement position of the second video in the video stream, so that the playing sequence number corresponding to the first video in the video playback page is adjacent to the playing sequence number corresponding to the second video in the video playback page, so that the second video may refer to the previous video or the next video corresponding to the first video, such as the video displayed by page 104 in FIG. 3.

The second prompt object refers to an object added on the video playback page displaying the second video, and used to prompt that the resource associated with the first video has been completely downloaded. Furthermore, the present application does not limit the implementation of the second prompt object. For example, it may be implemented with any object that can be used for information prompting, such as a prompt box, a control, or a prompt interface. It can be seen that in a possible implementation, the second prompt object may be implemented with prompt box 301 shown in FIG. 3.

In addition, the present application does not limit the position of the second prompt object on the video playback page. For example, it may be set according to the actual application scenario.

For another example, in order to further improve user experience, the present application further provides a possible implementation of the above second prompt object. In this implementation, a position of the second prompt object in the video playback page and a position of the second video in the video playback page satisfy a preset position constraint. The preset position constraint is used to ensure that an impact degree of displaying the second prompt object on displaying the second video does not exceed a preset threshold, such as reaching a minimum, so that interference caused by displaying the second prompt object can be reduced as much as possible, and thus interference to the video being played can be reduced as much as possible on the premise of adding prompt information, thereby being beneficial to improving user experience. It should be noted that the present application does not limit the determination method of the impact degree. For example, the impact degree may be determined according to a relative positional relationship between a display position of the second prompt object and a display position of the second video, and a size of an intersection between a display area of the second prompt object and a display area of the second video, so that the impact degree is not higher than impact degrees caused by other positions in a plurality of preset positions to the display of the second video except the display position of the second prompt object. The plurality of preset positions may refer to some candidate positions preset for the second prompt object.

In addition, in some application scenarios, such as application download scenarios, in order to better improve user experience, the present application further provides a possible implementation of the above second prompt object. In this implementation, the second prompt object may include a resource use control, such as installation control 302 shown in FIG. 3. Because the resource use control is used to trigger a use process for the resource associated with the first video that has been downloaded completely, such as an installation process of an application, a document opening process, an audio playing process, etc., so that the use process for the resource can be triggered by a trigger operation for the resource use control subsequently. It should be noted that the present application does not limit the implementation of the resource use control. For example, when the resource is an application, the resource use control may be implemented with an installation control, so that the resource use control is used to trigger an installation process for the resource. For another example, when the resource is a document, the resource use control may be implemented with an open control, so that the resource use control is used to trigger an opening process for the resource. For another example, when the resource is audio or video, the resource use control may be implemented with a play control, so that the resource use control is used to trigger a playing process for the resource.

Based on the related content of the above S1 to S2, it can be seen that for a video playback page displaying a first video, when the video playback page also displays a resource download control corresponding to the first video, the resource download control is used to trigger a download process of a resource associated with the first video displayed in the video playback page, so that after detecting a trigger operation for the resource download control, a download progress description object and a first prompt object are added and displayed on the video playback page, so that the download progress description object is used to describe a download progress of the resource, and the first prompt object is used to prompt that switching a video will not interrupt the downloading of the resource, so that the user can not only know the download progress of the resource from the video playback page, but also know from the video playback page that switching the video will not interrupt the downloading of the resource, so that the wrong perception of “must stay in the first video during resource download” can be effectively corrected, so that after switching the first video displayed in the video playback page to a second video, in response to determining that the resource has been completely downloaded, a second prompt object is added and displayed on the video playback page, so that the second prompt object is used to prompt that the resource has been completely downloaded, so that it can be realized that the video viewing rhythm of the user is further ensured to be unaffected on the premise of meeting the resource download requirements, thus defects caused by the user staying in the first video to wait for the resource to complete downloading or defects caused by the user choosing to interrupt the resource download due to being eager to view a subsequent video can be effectively avoided, thereby being beneficial to improving user experience, such as video viewing experience and resource download experience.

It is found through research that in some cases, such as when the user accidentally triggers the resource download process, the user may have a need to cancel the download. Based on this, the present application further provides a possible implementation of the above resource download method. In this implementation, when the display content of the above download progress description object includes a pause download identifier, the resource download method may include at least some or all of the following steps 11 to 15. The execution time of step 11 is later than the execution time of the above S1.

Step 11: in response to a trigger operation for the download progress description object displayed in the video playback page, cancelling displaying the download progress description object from the video playback page, and adding and displaying a continue download control and a cancel download control in the video playback page.

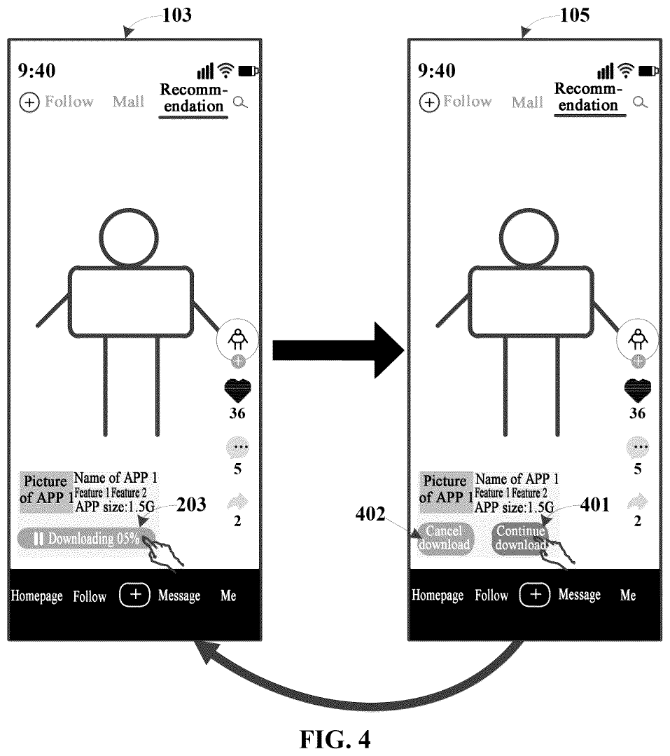

The continue download control refers to a control that appears when the downloading of the resource associated with the first video is paused and is used to trigger a continue download process of the resource, such as continue download control 401 shown in FIG. 4.

The cancel download control refers to a control that appears when the downloading of the resource associated with the first video is paused and is used to trigger a cancel download process of the resource, such as cancel download control 402 shown in FIG. 4.

Based on the related content of the above step 11, it can be seen that in some application scenarios, for a video playback page displaying the download progress description object, such as page 103 shown in FIG. 2 or FIG. 4, if a trigger operation for the download progress description object, such as a click operation, is detected, the download progress description object is cancelled from being displayed on the video playback page, and the continue download control and the cancel download control are added and displayed on the video playback page, so that the video playback page, such as page 105 shown in FIG. 4, can not only convey to the user that the resource associated with the first video is in a pause download state, but also convey to the user that the user can implement continuing to download the resource or cancelling the downloading of the resource with the help of certain operations, so that the expression of the resource state is relatively clear, thus being able to effectively avoid the user's confusion caused by an unclear expression of the resource state, which is beneficial to improving user experience. In addition, because the video playback page includes the cancel download control, the cancel download control can convey to the user that the user can trigger a cancel download process of the resource with the help of the cancel download control, so that the needs of some users to cancel the resource download can be better satisfied, thereby being beneficial to improving user experience.

Step 12: in response to a trigger operation for the continue download control displayed in the video playback page, cancelling displaying the continue download control and the cancel download control from the video playback page, and resuming displaying the download progress description object in the video playback page.

In the present application, in some application scenarios, for a video playback page displaying the continue download control, such as page 105 shown in FIG. 4, if a trigger operation for the continue download control is detected, the continue download control and the cancel download control are cancelled from being displayed on the video playback page, and the download progress description object is resumed to be displayed on the video playback page, so that the video playback page, such as page 103 shown in FIG. 4, can not only resume displaying the download progress of the resource associated with the first video, but also resume conveying to the user that the user can implement pausing downloading with the help of the download progress description object, which is beneficial to improving user experience.

Step 13: in response to a trigger operation for the cancel download control displayed in the video playback page, adding and displaying a cancel confirm object in the video playback page; the cancel confirm object is used to confirm whether to cancel the downloading of the resource associated with the first video.

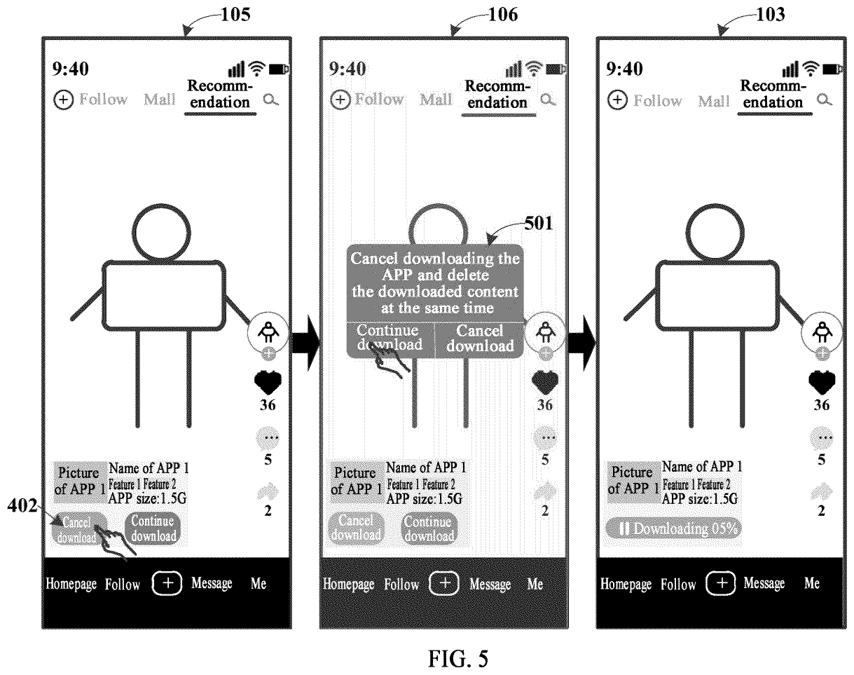

The cancel confirm object refers to an object displayed after the user triggers a cancel download operation for the resource associated with the first video, and used to perform secondary confirmation to the user on whether to cancel the downloading of the resource. Furthermore, the present application does not limit the implementation of the cancel confirm object. For example, it may be implemented with any object that can achieve a secondary confirmation effect, such as a pop-up window or a certain interface. It can be seen that in a possible implementation, the cancel confirm object may be implemented with secondary confirmation pop-up window 501 shown in FIG. 5.

In addition, the present application does not limit the display manner of the above cancel confirm object. For example, it may specifically be: in response to a trigger operation for the cancel download control displayed in the video playback page, adding a floating layer in a transparent state on the video playback page, such as a gry floating layer shown by page 106 in FIG. 5, and displaying the cancel confirm object on the floating layer, so that the user can not only see the cancel confirm object on the video playback page, but also see the related content of the resource on the video playback page, which is beneficial to better satisfying the information browsing needs of the user, thereby being beneficial to improving user experience. It should be noted that the present application does not limit the transparency of the floating layer, which can be set according to the actual application scenario.

In addition, the present application does not limit the execution time of the above step 13. For example, the execution time of step 13 is later than the execution time of the above step 11.

Based on the related content of the above step 13, it can be seen that in some application scenarios, for a video playback page displaying the cancel download control, such as page 105 shown in FIG. 4 or FIG. 5, if a trigger operation for the cancel download control is detected, a cancel confirm object is added and displayed on the video playback page, so that the cancel confirm object in the video playback page, such as page 106 shown in FIG. 5, can perform secondary confirmation to the user on whether to cancel the downloading of the resource associated with the first video, thus being able to effectively avoid defects caused by accidentally touching the cancel download control, thereby being beneficial to improving user experience.

Step 14: in response to a confirm cancel operation triggered for the cancel confirm object displayed in the video playback page, cancelling displaying the cancel confirm object from the video playback page, resuming displaying the resource download control in the video playback page, and adding and displaying a third prompt object in the video playback page; the third prompt object is used to prompt that the downloading of the resource has been cancelled.

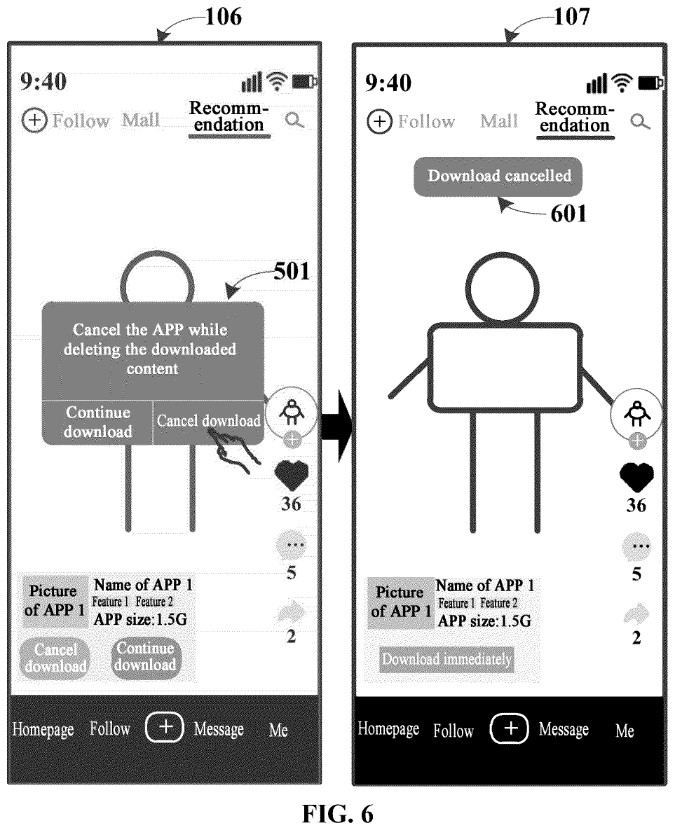

The confirm cancel operation refers to an operation triggered for the cancel confirm object and used to represent that the downloading is indeed to be cancelled. Furthermore, the present application does not limit the implementation of the confirm cancel operation. For example, when the cancel confirm object is implemented with secondary confirmation pop-up window 501 shown in FIG. 6, the confirm cancel operation may refer to a click operation triggered for a cancel download button in the cancel confirm object.

The third prompt object refers to an object that needs to be displayed after the downloading of the resource associated with the first video is cancelled, and used to convey to the user that the downloading of the resource has been cancelled. Furthermore, the present application does not limit the implementation of the third prompt object. For example, it may be implemented with any object that can perform prompt information, such as a prompt box, a control, or a prompt interface. It can be seen that in a possible implementation, the third prompt object may be implemented with prompt box 601 shown in FIG. 6.

In addition, the present application does not limit the display characteristics of the above third prompt object. For example, in some application scenarios, in order to reduce interference as much as possible, the third prompt object may disappear automatically after being displayed for a certain duration, such as 3 seconds, so that interference to the video display caused by the display of the third prompt object can be effectively reduced, thereby being beneficial to improving user experience.

Based on the related content of the above step 14, it can be seen that in some application scenarios, for a video playback page displaying the cancel confirm object, such as page 106 shown in FIG. 5 or FIG. 6, if a confirm cancel operation triggered for the cancel confirm object is detected, such as a click operation triggered for the cancel download button in secondary confirmation pop-up window 501 shown in FIG. 5 or FIG. 6, the cancel confirm object is cancelled from being displayed on the video playback page, the resource download control is resumed to be displayed on the video playback page, and the third prompt object is added and displayed on the video playback page, so that the video playback page, such as page 107 shown in FIG. 6, can not only resume conveying to the user how to download the resource associated with the first video, but also convey to the user that the downloading of the resource has been cancelled with the help of the third prompt object, so that the current state of the resource can be better known, thereby being beneficial to improving user experience.

Step 15: in response to an abort cancel operation triggered for the cancel confirm object displayed in the video playback page, cancelling displaying the cancel confirm object, the continue download control and the cancel download control from the video playback page, and resuming displaying the download progress description object in the video playback page.

The abort cancel operation refers to an operation triggered for the cancel confirm object and used to represent that cancelling the downloading is aborted. Furthermore, the present application does not limit the implementation of the abort cancel operation. For example, when the cancel confirm object is implemented with secondary confirmation pop-up window 501 shown in FIG. 5, the abort cancel operation may refer to a click operation triggered for a continue download button in the cancel confirm object.

In addition, the present application does not limit the execution time of the above step 15. For example, the execution time of step 15 is later than the execution time of the above step 13.

It can be seen that in some application scenarios, for a video playback page displaying the cancel confirm object, such as page 106 shown in FIG. 5, if an abort cancel operation triggered for the cancel confirm object is detected, such as a click operation triggered for the continue download button in secondary confirmation pop-up window 501 shown in FIG. 5, the cancel confirm object, the continue download control and the cancel download control are cancelled from being displayed on the video playback page, and the download progress description object is resumed to be displayed on the video playback page, so that the video playback page, such as page 103 shown in FIG. 5, can not only resume displaying the download progress of the resource associated with the first video, but also resume conveying to the user that the user can implement pausing downloading with the help of the download progress description object, which is beneficial to improving user experience.

Based on the related content of the above steps 11 to 15, it can be seen that the technical solutions provided in the present application not only support resource download and pause download, but also support cancel download, which can better meet the resource download requirements of different users, thereby being beneficial to improving user experience. In addition, the present application provides that the state of the resource, such as being in downloading, being in pause downloading, being in continue downloading, or being in cancel downloading, can be clearly expressed by means of some page elements, so that the user can clearly know the current state of the resource by means of these page elements, thereby being beneficial to improving user experience.

Actually, in some application scenarios, the present application further provides some possible implementations of the above resource download method. In this implementation, the resource download method may include at least the following step 21. The execution time of step 21 is later than the execution time of the above S1.

Step 21: in response to the first video being displayed on the video playback page when it is determined that the resource associated with the first video has been completely downloaded, cancelling displaying the download progress description object from the video playback page, and adding and displaying a resource use trigger object in the video playback page.

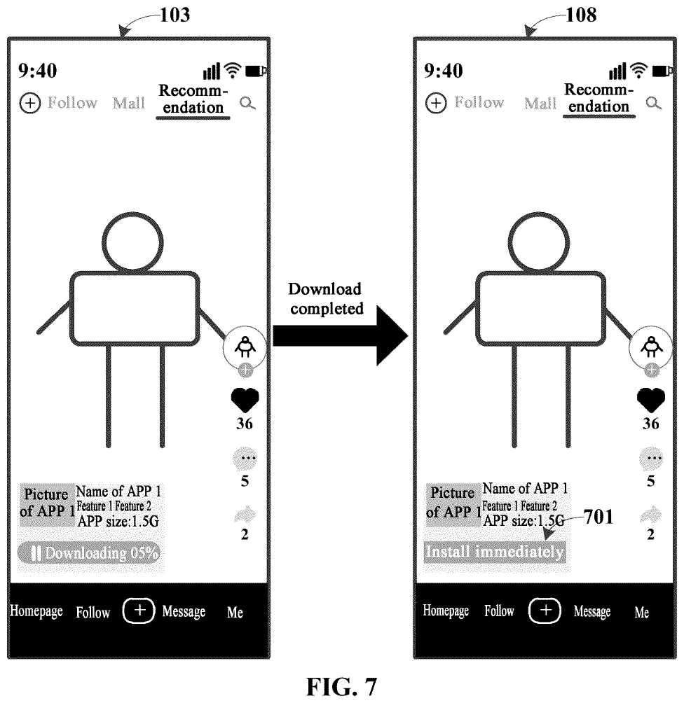

The resource use trigger object refers to an object added on the video playback page displaying the first video, and used to convey to the user that the resource has been completely downloaded and can be used. Furthermore, the present application does not limit the implementation of the resource use trigger object. For example, it may be implemented with any object that can convey to the user that the resource has been completely downloaded and can be used, such as a control, a window, an interface, etc. It can be seen that in a possible implementation, the resource use trigger object may be implemented with immediate installation control 701 shown in FIG. 7. For another example, the implementation of the resource use trigger object is similar to the implementation of the above resource use control.

Based on the related content of the above step 21, it can be seen that for some cases, such as the case where the video has not been switched all the time or the case where the video is finally switched back to the first video after multiple video switches, when it is detected that the resource associated with the first video has been completely downloaded, if the first video is being displayed on the video playback page at this time, the download progress description object may be cancelled from being displayed on the video playback page directly, and the resource use trigger object may be added on the video playback page, so that the resource use trigger object is displayed by occupying the position of the download progress description object in the video playback page, so that the video playback page, such as page 108 shown in FIG. 7, can not only convey to the user that the resource has been downloaded completely, but also convey to the user that the user can implement a use process for the resource with the help of the resource use trigger object, such as an installation process for an application, which is beneficial to improving user experience.

In addition, in order to better realize that the resource download is not interrupted when switching the video, the present application provides some possible implementations of the resource download method. For ease of understanding, the following will be described in combination with some cases.

Case 1, if the user has configured permission for background download for the display device of the video playback page in advance, the resource download method provided by the present application may include at least the following steps 31 to 32.

Step 31: in response to a trigger operation for a resource download control displayed in the video playback page, adding and displaying a download progress description object and a first prompt object in the video playback page, and starting to download the resource associated with the first video displayed in the video playback page in the background. The display content of the first prompt object includes the text “Background download has been started, and switching a video will not interrupt the downloading”.

It should be noted that the related content of step 31 is similar to the related content of the above S1, and details are not described herein again for the sake of brevity. It can be seen that in a possible implementation, the resource associated with the first video is downloaded in the background in response to the trigger operation for the above resource download control.

Step 32: after switching the first video displayed on the video playback page to a second video, in response to determining that the resource associated with the first video has been completely downloaded, adding and displaying a second prompt object on the video playback page; the second prompt object is used to prompt that the resource has been completely downloaded.

It should be noted that for the related content of step 32, reference may be made to the related content of the above S2, and details are not described herein again for the sake of brevity.

Based on the related content of the above steps 31 to 32, it can be seen that in some application scenarios, such as scenarios where the display device of the video playback page is in permission for background download, for a video playback page, such as page 101 shown in FIG. 2, if the video playback page is displaying a first video and a resource download control corresponding to the first video, after detecting a trigger operation for the resource download control, the resource associated with the first video is downloaded in the background, the resource download control is cancelled from being displayed on the video playback page, and a download progress description object and a first prompt object are added and displayed on the video playback page, such as prompt box 202 shown in FIG. 2, so that the display content of the first prompt object includes the text “Background download has been started, and switching a video will not interrupt the downloading”, so that the video playback page, such as page 102 shown in FIG. 2, can convey to the user, with the help of the first prompt object, information such as: the resource is in a background download state and the user can switch the video at will during the resource download, thus the resource is still in the background download state after the first video displayed on the video playback page is switched to a second video, so that when it is detected that the resource has been completely downloaded, a second prompt object can be directly added and displayed on the video playback page, so that the video playback page, such as page 104 shown in FIG. 3, can convey to the user, with the help of the second prompt object, information such as: the resource has been completely downloaded, thus being able to not only meet the resource download requirements of the user, but also meet the video switch requirements of the user, thereby being beneficial to improving user experience. Because the resource is downloaded in the background in response to the trigger operation for the resource download control, the user can directly switch the video after triggering the resource download control, without waiting, so that the impact of the resource download on the browsing of the video stream can be reduced as much as possible, thus being able to achieve improving the video stream viewing experience of the user as much as possible on the premise of realizing the resource download.

Case 2, if the user has not configured permission for background download for the display device of the video playback page in advance or the user has configured rejection for background download for the display device of the video playback page in advance, the resource download method provided by the present application may include at least the following steps 41 to 44.

Step 41: in response to a trigger operation for a resource download control displayed in the video playback page, adding and displaying a download progress description object and a first prompt object in the video playback page, and starting to directly download the resource associated with the first video displayed in the video playback page. The display content of the first prompt object includes the text “Background download is supported, and switching a video will not interrupt the downloading”.

It should be noted that the “direct download” in step 41 refers to non-background download, and the “direct download” may be interrupted when switching the video.

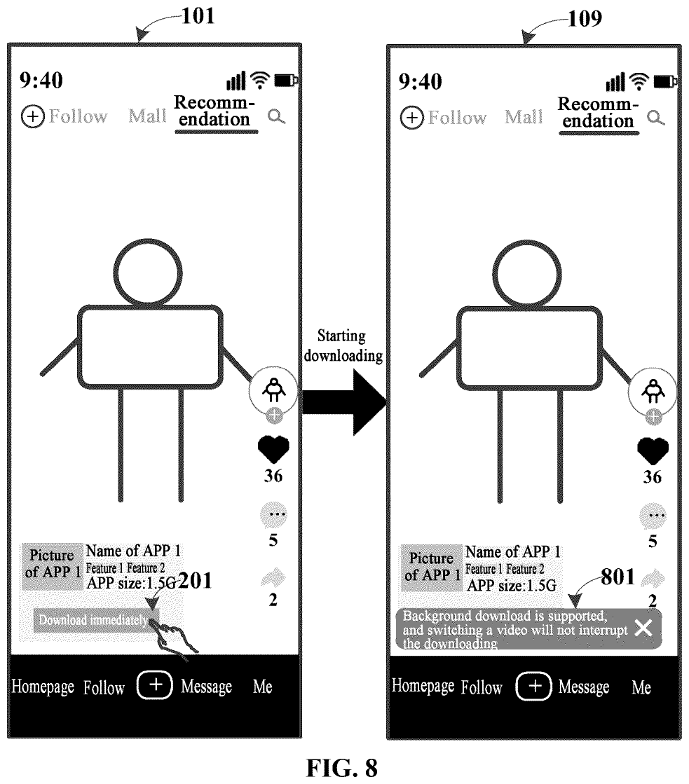

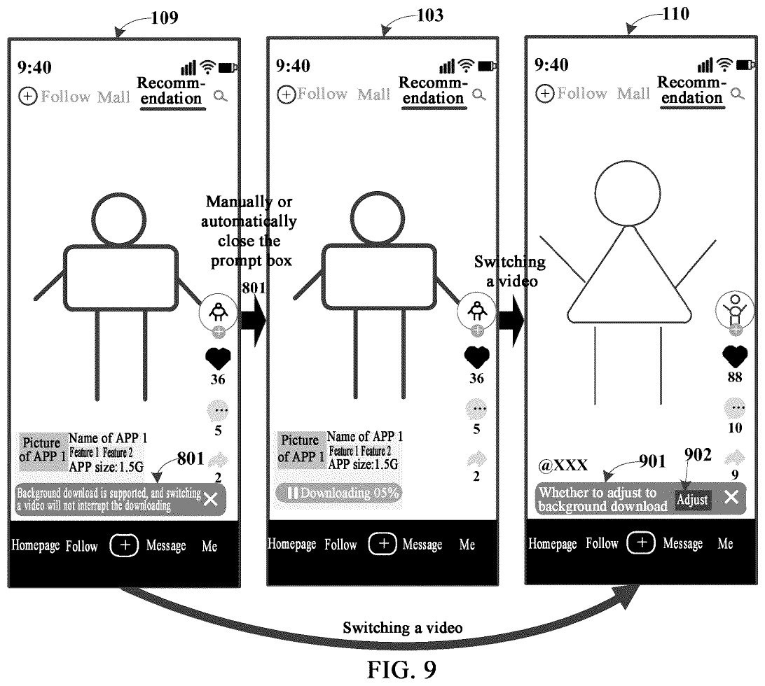

It should also be noted that the interaction flow related to the first prompt object in step 41 is similar to the interaction flow related to the first prompt object in the above S1, and details are not described herein again for the sake of brevity. It can be seen that in a possible implementation, for the first prompt object in step 41, such as prompt box 801 shown in FIG. 8, when the first prompt object is displayed by covering the download progress description object, the interaction flow related to the first prompt object may include: in response to determining that the display duration of the first prompt object reaches a preset duration threshold or a close operation for the first prompt object being triggered, such as a click operation for the close button in prompt box 801 shown in FIG. 8 or FIG. 9, the first prompt object is cancelled from being displayed on the video playback page, so that the video playback page, such as page 103 shown in FIG. 9, can better display the resource download progress to the user.

It should be further noted that the related content of step 41 is similar to the related content of the above S1, and details are not described herein again for the sake of brevity.

Based on the related content of the above step 41, it can be seen that in some application scenarios, such as scenarios where the display device of the video playback page is not in permission for background download, for a video playback page, such as page 101 shown in FIG. 8, if the video playback page is displaying a first video and a resource download control corresponding to the first video, after detecting a trigger operation for the resource download control, the resource associated with the first video is directly downloaded, the resource download control is cancelled from being displayed on the video playback page, and a download progress description object and a first prompt object are added and displayed on the video playback page, such as prompt box 801 shown in FIG. 8, so that the display content of the first prompt object includes the text “Background download is supported, and switching a video will not interrupt the downloading”, so that the video playback page, such as page 109 shown in FIG. 8, can convey to the user, with the help of the first prompt object, information such as: the resource supports the background download state and the user is allowed to switch the video during the resource download, thus being able to not only meet the resource download requirements of the user, but also meet the video switch requirements of the user, thereby being beneficial to improving user experience.

Step 42: after switching the first video displayed on the video playback page to a second video, adding and displaying a background download confirm object on the video playback page; the background download confirm object is used to confirm whether to adjust to download the resource associated with the first video in the background.

The background download confirm object refers to an object that needs to be displayed after a video switch operation is triggered for the video playback page displaying the first video, and used to confirm to the user whether to adjust to download the resource associated with the first video in the background. Furthermore, the present application does not limit the implementation of the background download confirm object. For example, it may be implemented with any object that can be used for information confirmation, such as a prompt box, a control, or a prompt interface. It can be seen that in a possible implementation, the background download confirm object may be implemented with prompt box 901 shown in FIG. 9.

In addition, the present application does not limit the position of the above background download confirm object on the video playback page. For example, it may be set according to the actual application scenario.

For another example, in order to further improve user experience, the present application further provides a possible implementation of the above background download confirm object. In this implementation, a position of the background download confirm object in the video playback page and a position of the second video in the video playback page satisfy a preset position constraint. The preset position constraint is used to ensure that an impact degree of displaying the background download confirm object on displaying the second video does not exceed a preset threshold, such as reaching a minimum, so that interference caused by displaying the background download confirm object can be reduced as much as possible, and thus interference to the video being played can be reduced as much as possible on the premise of adding prompt information, thereby being beneficial to improving user experience.

Based on the related content of the above step 42, it can be seen that in some application scenarios, for a video playback page displaying a first video and a first prompt object, such as page 109 shown in FIG. 9 or page 103 shown in FIG. 9, if a video switch operation triggered for the video playback page is detected, not only the first video displayed on the video playback page needs to be switched to a second video, but also a background download confirm object needs to be added and displayed on the video playback page, so that the video playback page, such as page 110 shown in FIG. 9, can confirm to the user, with the help of the background download confirm object, whether to adjust to download the resource associated with the first video in the background, so that the user can directly adjust the download manner of the resource with the help of the background download confirm object, which is beneficial to improving the adjustment efficiency of the download manner, thus being able to reduce the impact of the resource download on the browsing of the video stream as much as possible, thereby being beneficial to improving user experience. It should be noted that the present application does not limit the implementation of the video switch operation. For example, it may be implemented with any operation that can trigger video switching, such as an up or down sliding operation, a click on a video switch button, etc.

Step 43: in response to a confirm background download operation triggered for the background download confirm object displayed on the video playback page, cancelling displaying the background download confirm object from the video playback page, and adjusting the download manner of the resource associated with the first video to background download.

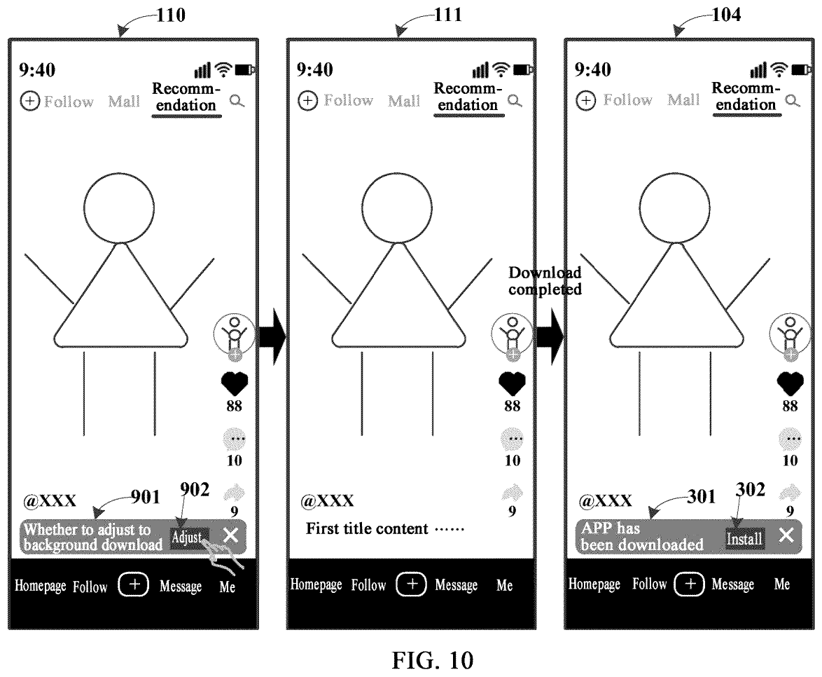

The confirm background download operation refers to an operation triggered for the background download confirm object and used to represent that the download manner of the resource associated with the first video is indeed to be adjusted to background download. Furthermore, the present application does not limit the implementation of the confirm background download operation. For example, when the background download confirm object is implemented with prompt box 901 shown in FIG. 9 or FIG. 10, the confirm background download operation may refer to a click operation triggered for adjust control 902 in the background download confirm object.

Based on the related content of the above step 43, it can be seen that in some application scenarios, for a video playback page displaying the background download confirm object, such as page 110 shown in FIG. 10, if a confirm background download operation triggered for the background download confirm object is detected, the background download confirm object is cancelled from being displayed on the video playback page, and the download manner of the resource associated with the first video is adjusted to background download, so that the video playback page, such as page 111 shown in FIG. 10, can display the second video normally during the resource download, thus being able to effectively avoid the interference caused by the resource download to the user's browsing of the video stream, thereby being beneficial to improving user experience.

Step 44: in response to determining that the resource associated with the first video has been completely downloaded, adding and displaying a second prompt object on the video playback page; the second prompt object is used to prompt that the resource has been completely downloaded.

It should be noted that for the related content of step 44, reference may be made to the related content of the above S2, and details are not described herein again for the sake of brevity.

Based on the related content of the above steps 41 to 44, it can be seen that in some application scenarios, such as scenarios where the display device of the video playback page is not in permission for background download, for a video playback page, such as page 101 shown in FIG. 8, if the video playback page is displaying a first video and a resource download control corresponding to the first video, after detecting a trigger operation for the resource download control, the resource associated with the first video is directly downloaded, the resource download control is cancelled from being displayed on the video playback page, and a download progress description object and a first prompt object are added and displayed on the video playback page, such as prompt box 801 shown in FIG. 8, so that the display content of the first prompt object includes the text “Background download is supported, and switching a video will not interrupt the downloading”, so that the video playback page, such as page 109 shown in FIG. 8 or FIG. 9, can convey to the user, with the help of the first prompt object, information such as: the video switching during the resource download can be realized by means of background download, thus when a video switch operation triggered for the video playback page is detected, the first video displayed on the video playback page is switched to a second video, and a background download confirm object is added and displayed on the video playback page, such as control 901 shown in FIG. 9, so that the video playback page, such as page 110 shown in FIG. 9, can confirm to the user, with the help of the background download confirm object, whether to adjust to download the resource associated with the first video in the background, so that when a confirm background download operation triggered for the background download confirm object is detected, the background download confirm object is cancelled from being displayed on the video playback page, and the download manner of the resource associated with the first video is adjusted to background download, so that the video playback page, such as page 111 shown in FIG. 10, can display the second video normally during the resource download, and when it is detected that the resource has been completely downloaded, a second prompt object is directly added and displayed on the video playback page, so that the video playback page, such as page 104 shown in FIG. 10, can convey to the user, with the help of the second prompt object, information such as: the resource has been completely downloaded, thus being able to not only meet the resource download requirements of the user, but also meet the video switch requirements of the user, thereby being beneficial to improving user experience. Because the background download confirm object is displayed in response to the video switch operation triggered by the user, the user can accurately know that the background download only occurs in the video switch scenario, which is beneficial to improving the resource download experience of the user.

In addition, for the interaction flow shown in the above paragraph, in a possible implementation, when a video switch operation is detected, the first video may be switched to the second video first, and then the background download confirm object is displayed, so as to ensure that the video switching efficiency is not reduced, thus being able to realize that the resource download requirements of the user are met on the premise of ensuring that the resource download does not affect the video switching efficiency, thereby being beneficial to improving the video stream viewing experience of the user.

In addition, in some application scenarios, the user can implement cancelling the download with the help of a video switch operation, which is beneficial to enriching the implementation paths of cancelling the download, thereby being able to better meet the user's needs for cancelling the download. Based on this, the present application further provides a possible implementation of the above resource download method. In this implementation, the resource download method may include at least the above steps 41 to 42 and the following step 45.

Step 45: in response to an abort background download operation triggered for the background download confirm object displayed on the video playback page, cancelling displaying the background download confirm object from the video playback page, and adding and displaying a third prompt object on the video playback page; the third prompt object is used to prompt that the downloading of the resource has been cancelled.

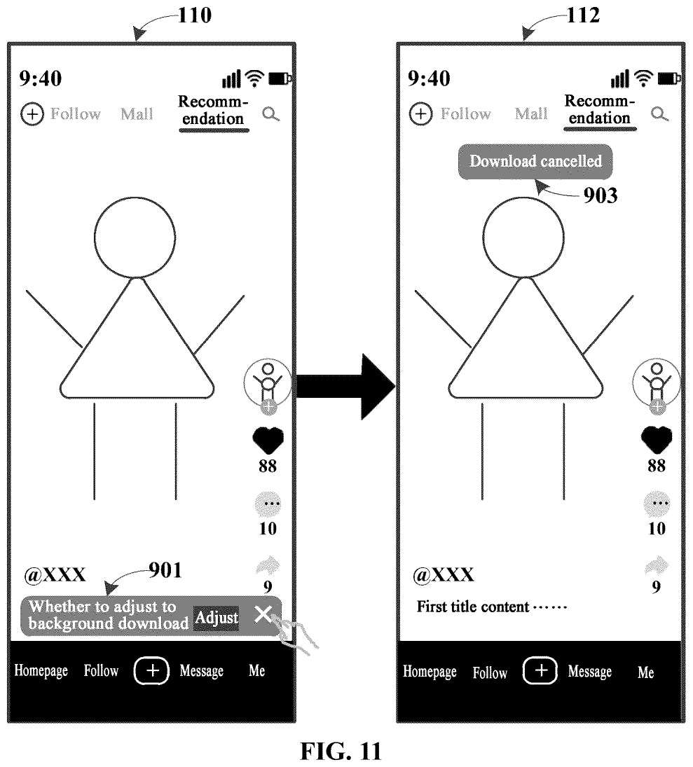

The abort background download operation refers to an operation triggered for the background download confirm object and used to represent that adjusting the download manner of the resource associated with the first video to background download is aborted. Furthermore, the present application does not limit the implementation of the abort background download operation. For example, when the background download confirm object is implemented with prompt box 901 shown in FIG. 9 or FIG. 11, the abort background download operation may refer to a click operation triggered for the close button “×” in the background download confirm object.

In addition, for the related content of the third prompt object in step 45, reference may be made to the related content of the third prompt object in the above step 14, and details are not described herein again for the sake of brevity.

Based on the related content of the above step 45, it can be seen that in some application scenarios, for a video playback page displaying the background download confirm object, such as page 110 shown in FIG. 11, if an abort background download operation triggered for the background download confirm object is detected, the resource associated with the above first video is cancelled, the downloaded content of the resource is deleted, the background download confirm object is cancelled from being displayed on the video playback page, and the third prompt object, such as prompt box 903 shown in FIG. 11, is added and displayed on the video playback page, so that the video playback page, such as page 112 shown in FIG. 11, can convey to the user, with the help of the third prompt object, information such as: the downloading of the resource has been cancelled, so that the user can clearly know the state of the resource with the help of the third prompt object, thereby being beneficial to improving user experience.

In addition, in order to better improve the user's resource usage requirements, the present application further provides a possible implementation of the above resource download method. In this implementation, the resource download method may include at least the following steps 51 to 52. The execution time of step 51 is later than the execution time of the above S2, the execution time of the above step 32, or the execution time of the above step 44.

Step 51: when the video playback page is displaying the second video and the second prompt object, in response to a video switch operation triggered for the video playback page, switching the second video displayed on the video playback page to a third video, and maintaining displaying the second prompt object on the video playback page. The second prompt object includes a resource use control; the resource use control is used to trigger a use process for the resource associated with the first video that has been downloaded completely.

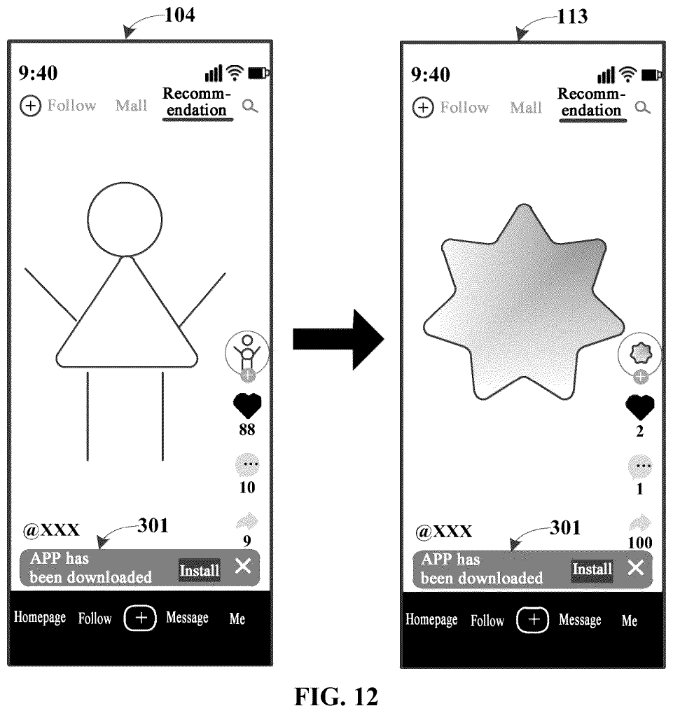

The third video refers to a video to be switched to when switching a video for a video playback page displaying the second video, such as the video displayed by page 113 in FIG. 12. Furthermore, the present application does not limit the third video. For example, in a possible implementation, when the video playback page is used to play part or all of the videos in the video stream in sequence, the third video satisfies the following constraint: an arrangement position of the third video in the video stream is adjacent to an arrangement position of the second video in the video stream, and the third video is different from the above first video.

Step 52: in response to a trigger operation for the resource use control in the second prompt object displayed on the video playback page, cancelling displaying the second prompt object from the video playback page, and executing the use process for the resource associated with the first video.

Based on the related content of the above steps 51 to 52, it can be seen that in some application scenarios, when the video playback page, such as page 104 shown in FIG. 12, is displaying the second video and the second prompt object, if a video switch operation triggered for the video playback page is detected, not only the second video displayed on the video playback page needs to be switched to a third video, but also the second prompt object needs to be maintained to be displayed on the video playback page, such as prompt box 301 shown in FIG. 12, so that the video playback page can not only meet the video switch requirements of the user, but also continue to prompt the user that the user can trigger the use process for the resource associated with the first video with the help of the second prompt object, thus being able to realize giving the user a resource usage prompt during frequent video switching, so that the impact caused by the user having difficulty finding the resource usage entry after accidentally switching the video can be effectively avoided, thereby being beneficial to improving user experience.

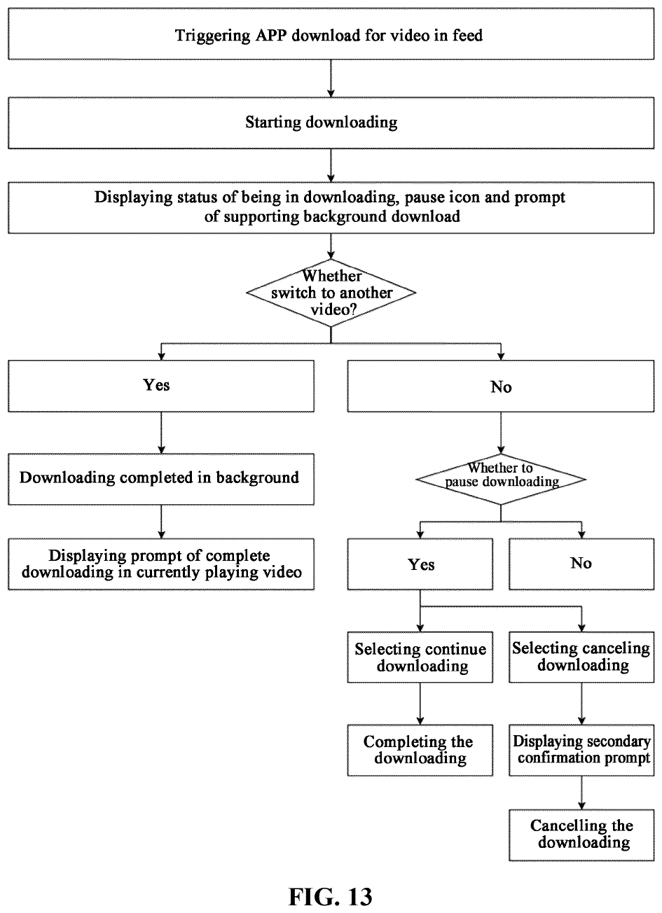

Based on the related content of the above resource download method, it can be seen that the technical solutions provided in the present application, such as the resource download process shown in FIG. 1 to FIG. 13, at least have the following advantages \textcircled{1} to \textcircled{3}.

\textcircled{1} The operations are clear in expression, which specifically is: the technical solutions provided in the present application can clearly express various states of the resource, such as being in download triggering, being in downloading, being in pause downloading, being in continue downloading, being in cancel downloading, being in complete downloading, being in installation triggering, etc., so that the user can clearly know the real-time state of the resource, thus being able to effectively avoid the user's confusion, thereby being beneficial to improving user experience.

\textcircled{2} The resource-related operations are complete, which specifically is: the technical solutions provided in the present application support a resource download trigger operation, a pause download trigger operation, a continue download trigger operation, a cancel download trigger operation, and a resource installation trigger operation, etc., so that the technical solutions provided in the present application can meet any operation requirements of the user for the resource, thus being able to effectively avoid the impact caused by being unable to meet certain resource operation requirements of the user, such as the requirement of cancelling the resource download, thereby being beneficial to improving user experience.

\textcircled{3} The resource download completion rate is improved, which specifically is: the present application ensures that the resource can still be downloaded after switching the video by means of background download, so that the resource download can be successfully completed on the premise of meeting the video stream viewing needs of the user, thus defects caused by the user having to interrupt the resource download in advance when the user wants to switch the video can be effectively avoided, thereby being able to realize improving the resource download completion rate without affecting the video viewing experience of the user.

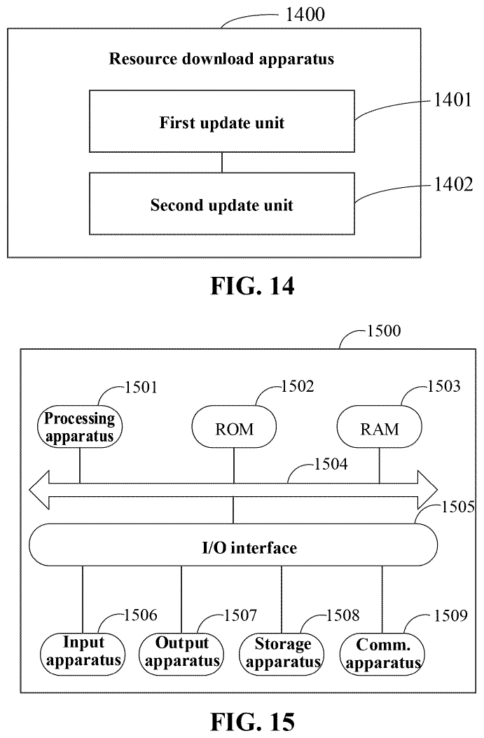

Based on the resource download method provided by the embodiments of the present application, the embodiments of the present application further provide a resource download apparatus, which will be explained and illustrated below in conjunction with FIG. 14. FIG. 14 is a schematic structural diagram of a resource download apparatus provided by an embodiment of the present application. It should be noted that for technical details of the resource download apparatus provided by the embodiments of the present application, reference may be made to the related content of the above resource download method.

As shown in FIG. 14, the resource download apparatus 1400 provided by the embodiment of the present application includes:
a first update unit 1401, configured to, in response to a trigger operation for a resource download control displayed in a video playback page, add and display a download progress description object and a first prompt object in the video playback page; the resource download control is used to trigger a download process of a resource associated with a first video displayed in the video playback page; the download progress description object is used to describe a download progress of the resource; the first prompt object is used to prompt that switching a video will not interrupt the downloading of the resource;
a second update unit 1402, configured to, after switching the first video displayed in the video playback page to a second video, in response to determining that the resource has been completely downloaded, add and display a second prompt object in the video playback page; the second prompt object is used to prompt that the resource has been completely downloaded.

In a possible implementation, the video playback page is used to play part or all of videos in a video stream in sequence; an arrangement position of the first video in the video stream is adjacent to an arrangement position of the second video in the video stream.

In a possible implementation, the resource is an application.

In a possible implementation, a position of the second prompt object in the video playback page and a position of the second video in the video playback page satisfy a preset position constraint; the preset position constraint is used to ensure that an impact degree of displaying the second prompt object on displaying the second video does not exceed a preset threshold.

In a possible implementation, the first prompt object is displayed by covering the download progress description object;
the resource download apparatus 1400 further includes:
a third update unit, configured to, after adding and displaying the download progress description object and the first prompt object in the video playback page, in response to determining that a display duration of the first prompt object reaches a preset duration threshold or a close operation for the first prompt object being triggered, cancel displaying the first prompt object from the video playback page.

In a possible implementation, the display content of the download progress description object includes a pause download identifier;
the resource download apparatus 1400 further includes:
a fourth update unit, configured to, after adding and displaying the download progress description object and the first prompt object in the video playback page, in response to a trigger operation for the download progress description object, cancel displaying the download progress description object from the video playback page, and add and display a continue download control and a cancel download control in the video playback page;
a fifth update unit, configured to, in response to a trigger operation for the continue download control, cancel displaying the continue download control and the cancel download control from the video playback page, and resume displaying the download progress description object in the video playback page.

In a possible implementation, the resource download apparatus 1400 further includes:
a sixth update unit, configured to, after adding and displaying the continue download control and the cancel download control on the video playback page, in response to a trigger operation for the cancel download control, add and display a cancel confirm object on the video playback page; the cancel confirm object is used to confirm whether to cancel the downloading of the resource;
a seventh update unit, configured to, in response to a confirm cancel operation triggered for the cancel confirm object, cancel displaying the cancel confirm object from the video playback page, resume displaying the resource download control on the video playback page, and add and display a third prompt object on the video playback page; the third prompt object is used to prompt that the downloading of the resource has been cancelled; or
an eighth update unit, configured to, in response to an abort cancel operation triggered for the cancel confirm object, cancel displaying the cancel confirm object, the continue download control and the cancel download control from the video playback page, and resume displaying the download progress description object on the video playback page.

In a possible implementation, the resource is downloaded in the background in response to the trigger operation for the resource download control.

In a possible implementation, the second update unit 1402 is specifically configured to: after switching the first video displayed on the video playback page to a second video, add and display a background download confirm object on the video playback page; the background download confirm object is used to confirm whether to adjust to download the resource in the background; in response to a confirm background download operation triggered for the background download confirm object, cancel displaying the background download confirm object from the video playback page.

In a possible implementation, the second update unit 1402 is further configured to: in response to an abort background download operation triggered for the background download confirm object, cancel displaying the background download confirm object from the video playback page, and add and display a third prompt object on the video playback page; the third prompt object is used to prompt that the downloading of the resource has been cancelled.

In a possible implementation, the second prompt object includes a resource use control; the resource use control is used to trigger a use process for the resource that has been downloaded completely;
the resource download apparatus 1400 further includes:
a ninth update unit, configured to, after adding and displaying the second prompt object on the video playback page, in response to a video switch operation triggered for the video playback page, switch the second video displayed on the video playback page to a third video, and maintain displaying the second prompt object on the video playback page;
a tenth update unit, configured to, in response to a trigger operation for the resource use control, cancel displaying the second prompt object from the video playback page.

Based on the related content of the above resource download apparatus 1400, it can be seen that the working principle of the resource download apparatus 1400 provided in the present application includes: for a video playback page displaying a first video, when the video playback page also displays a resource download control corresponding to the first video, the resource download control is used to trigger a download process of a resource associated with the first video displayed in the video playback page, so that after detecting a trigger operation for the resource download control, a download progress description object and a first prompt object are added and displayed on the video playback page, so that the download progress description object is used to describe a download progress of the resource, and the first prompt object is used to prompt that switching a video will not interrupt the downloading of the resource, so that the user can not only know the download progress of the resource from the video playback page, but also know from the video playback page that switching the video will not interrupt the downloading of the resource, so that the wrong perception of “must stay in the first video during resource download” can be effectively corrected, so that after switching the first video displayed on the video playback page to a second video, in response to determining that the resource has been completely downloaded, a second prompt object is added and displayed on the video playback page, so that the second prompt object is used to prompt that the resource has been completely downloaded, so that it can be realized that the video viewing rhythm of the user is further ensured to be unaffected on the premise of meeting the resource download requirements, thus defects caused by the user staying in the first video to wait for the resource to complete downloading or defects caused by the user choosing to interrupt the resource download due to being eager to view a subsequent video can be effectively avoided, thereby being beneficial to improving user experience, such as video viewing experience and resource download experience.

In addition, the embodiments of the present application further provide an electronic device, the device includes a processor and a memory, where the memory is configured to store instructions or computer programs, and the processor is configured to execute the instructions or computer programs in the memory, so that the electronic device executes any implementation of the resource download method provided by the embodiments of the present application.

Referring to FIG. 15, it shows a schematic structural diagram of an electronic device 1500 suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a tablet computer, a portable multimedia player (PMP), a vehicle-mounted terminal (for example, a vehicle-mounted navigation terminal), etc., and a stationary terminal such as a digital TV, a desktop computer, etc. The electronic device shown in FIG. 15 is only an example, and should not bring any limitation to the functions and the range of use of the embodiments of the present disclosure.

As shown in FIG. 15, the electronic device 1500 may include a processing apparatus (e.g., a central processing unit, a graphics processing unit, etc.) 1501 that can perform various appropriate actions and processing according to a program stored in a read only memory (ROM) 1502 or a program loaded from a storage apparatus 1508 into a random access memory (RAM) 1503. The RAM 1503 further stores various programs and data required for operations of the electronic device 1500. The processing apparatus 1501, the ROM 1502, and the RAM 1503 are connected to each other through a bus 1504. An input/output (I/O) interface 1505 is also connected to the bus 1504.

Usually, the following apparatuses may be connected to the I/O interface 1505: an input apparatus 1506 including, for example, a touch screen, a touch pad, a keyboard, a mouse, a camera, a microphone, an accelerometer, a gyroscope, etc.; an output apparatus 1507 including, for example, a liquid crystal display (LCD), a speaker, a vibrator, etc.; the storage apparatus 1508 including, for example, a magnetic tape, a hard disk, etc.; and a communication apparatus 1509. The communication apparatus 1509 may allow the electronic device 1500 to perform wireless or wired communication with other devices to exchange data. Although FIG. 15 shows the electronic device 1500 having various apparatuses, it should be understood that it is not required to implement or have all of the illustrated apparatuses. It may be an alternative to implement or have more or fewer apparatuses.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, where the computer program includes program codes for executing the methods shown in the flowcharts. In such an embodiment, the computer program may be downloaded and installed from a network through the communication apparatus 1509, or installed from the storage apparatus 1508, or installed from the ROM 1502. When the computer program is executed by the processing apparatus 1501, the above-mentioned functions defined in the methods of the embodiments of the present disclosure are executed.

The electronic device provided by the embodiments of the present disclosure belongs to the same inventive concept as the method provided by the above embodiments. For the technical details that have not been described in detail in the present embodiment, reference may be made to the above embodiments, and the present embodiment has the same beneficial effects as the above embodiments.

The embodiments of the present application further provide a computer-readable medium, where the computer-readable medium stores instructions or a computer program, and when the instructions or the computer program are run on a device, the device is caused to execute any implementation of the resource download method provided by the embodiments of the present application.

It should be noted that the above computer-readable medium in the present disclosure may be a computer-readable signal medium or a computer-readable storage medium or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination thereof. In the present disclosure, the computer-readable storage medium may be any tangible medium that contains or stores a program. The program may be used by or in combination with an instruction execution system, apparatus, or device. In the present disclosure, the computer-readable signal medium may include a data signal propagated in a baseband or as a part of a carrier, and computer-readable program codes are carried therein. The data signal propagated in this manner may take a variety of forms, including, but not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including, but not limited to, a wire, an optical cable, radio frequency (RF), etc., or any suitable combination thereof.

In some implementations, the client and the server can communicate using any currently known or future-developed network protocols, such as the Hypertext Transfer Protocol (HTTP), and can be interconnected with any form or medium of digital data communication (for example, a communication network). Examples of the communication network include a local area network (“LAN”), a wide area network (“WAN”), an internet (for example, the Internet), a peer-to-peer network (for example, an ad hoc peer-to-peer network), and any currently known or future-developed network.

The above computer-readable medium may be included in the above electronic device, or may exist alone without being assembled into the electronic device.

The above computer-readable medium carries one or more programs, and when the above one or more programs are executed by the electronic device, the electronic device is enabled to execute the above method.

The computer program codes for performing the operations of the present disclosure may be written in one or more programming languages or a combination thereof, where the above programming languages include but are not limited to object-oriented programming languages such as Java, Smalltalk, C++, and also include conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the case of involving the remote computer, the remote computer may be connected to the user's computer through any kind of network, including a local area network (LAN) or a wide area network (WAN), or may be connected to an external computer (for example, connected via the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing the specified logical functions. It should also be noted that, in some alternative implementations, the functions marked in the blocks may also occur in a different order than the order marked in the drawings. For example, two blocks shown in succession may, in fact, be executed substantially concurrently, or the blocks may sometimes be executed in the reverse order, depending upon the functionality involved. It should also be noted that, each block in the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The units involved in the embodiments of the present disclosure may be implemented in software or in hardware. Wherein, the name of a unit/module does not constitute a limitation on the unit itself under certain circumstances.

The functions described above herein may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine readable medium may be a tangible medium, which may contain or store a program for use by or in combination with an instruction execution system, apparatus or device. The machine readable medium may be a machine readable signal medium or a machine readable storage medium. The machine readable medium may include, but is not limited to, an electronic, magnetic, optical, electromagnetic, infrared, or semiconductor system, apparatus or device, or any suitable combination thereof. More specific examples of the machine readable storage medium may include an electrical connection with one or more wires, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination thereof.

It should be noted that the various embodiments in this specification are described in a progressive manner, and the differences between the embodiments are emphasized in each embodiment. For the same or similar parts between the embodiments, reference may be made to each other. For the system or apparatus disclosed in the embodiments, because it corresponds to the method disclosed in the embodiments, it is described relatively simply, and reference may be made to the description of the method for relevant parts.

It should be understood that in the present application, “at least one” refers to one or more, and “a plurality” refers to two or more. “And/or” is used to describe the association relationship between associated objects, indicating that there may be three relationships, for example, “A and/or B” may mean: only A exists, only B exists, and both A and B exist at the same time, where A and B may be singular or plural. The character “/” generally means that the associated objects before and after are in an “or” relationship. “At least one of the following items” or similar expressions refer to any combination of these items, including any combination of a single item or a plurality of items. For example, at least one of a, b, or c may mean: a, b, c, “a and b”, “a and c”, “b and c”, or “a and b and c”, where a, b, c may be singular or plural.

It should be further noted that in this specification, the relational terms such as first and second are only used to distinguish one entity or operation from another entity or operation, and do not necessarily require or imply that there is any such actual relationship or order between these entities or operations. Moreover, the term “include/comprise” or any other variants thereof are intended to cover non-exclusive inclusion, so that a process, method, article or device including a series of elements not only includes those elements, but also includes other elements not explicitly listed, or elements inherent to such process, method, article or device. Without more limitations, the elements defined by the sentence “include/comprise one . . . ” do not exclude that there are other same elements in the process, method, article or device including the elements.

The steps of the method or algorithm described in conjunction with the embodiments disclosed herein may be implemented directly by hardware, software modules executed by a processor, or a combination thereof. The software modules may be placed in random access memory (RAM), memory, read-only memory (ROM), electrically programmable ROM, electrically erasable programmable ROM, register, hard disk, removable disk, CD-ROM, or any other form of storage medium known in the art.

The above description of the disclosed embodiments enables any person skilled in the art to make or use the present application. Various modifications to these embodiments will be readily apparent to those skilled in the art, and the general principles defined herein may be implemented in other embodiments without departing from the spirit or scope of the present application. Therefore, the present application is not limited to these embodiments shown herein, but is to be accorded the widest scope consistent with the principles and novel features disclosed herein.

I/We claim:

1. A method for downloading resources, comprising:
in response to a trigger operation for a resource download control displayed in a video playback page, adding and displaying a download progress description object and a first prompt object in the video playback page, the resource download control being used to trigger a download process of a resource associated with a first video being displayed in the video playback page, the download progress description object being used to describe a download progress of the resource, and the first prompt object being used to prompt that switching a video does not interrupt the downloading of the resource; and
after switching the first video displayed in the video playback page to a second video, in response to determining that the resource has been completely downloaded, adding and displaying a second prompt object in the video playback page, the second prompt object being used to prompt that the resource has been completely downloaded.

2. The method according to claim 1, wherein the video playback page is used to play a part or all of videos in a video stream in sequence; and
an arrangement position of the first video in the video stream is adjacent to an arrangement position of the second video in the video stream.

3. The method according to claim 1, wherein the resource comprises an application.

4. The method according to claim 1, wherein a position of the second prompt object in the video playback page and a position of the second video in the video playback page satisfy a preset position constraint, and the preset position constraint is used to ensure that an impact degree of displaying the second prompt object on displaying the second video does not exceed a preset threshold.

5. The method according to claim 1, wherein the first prompt object is displayed by covering the download progress description object; and
the method further comprises, after adding and displaying the download progress description object and the first prompt object in the video playback page,
in response to determining that a display duration of the first prompt object reaches a preset duration threshold or a close operation for the first prompt object being triggered, cancelling displaying the first prompt object from the video playback page.

6. The method according to claim 1, wherein the display content of the download progress description object comprises a pause download identifier, and
the method further comprises, after adding and displaying the download progress description object and the first prompt object in the video playback page,
in response to a trigger operation for the download progress description object, canceling displaying the download progress description object from the video playback page, and adding and displaying a continue download control and a cancel download control in the video playback page; and
in response to a trigger operation for the continue download control, cancelling displaying the continue download control and the cancel download control from the video playback page, and resuming displaying the download progress description object in the video playback page.

7. The method according to claim 6, wherein the method further comprises, after adding and displaying the continue download control and the cancel download control in the video playback page,
in response to a trigger operation for the cancel download control, adding and displaying a cancel confirm object in the video playback page, the cancel confirm object being used to confirm whether to cancel the downloading of the resource;
in response to a confirm cancel operation triggered for the cancel confirm object, canceling displaying the cancel confirm object from the video playback page, and resuming displaying the resource download control in the video playback page, and adding and displaying a third prompt object in the video playback page, the third prompt object being used to prompt that the downloading of the resource has been cancelled; or
in response to an abort cancel operation triggered for the cancel confirm object, canceling displaying the cancel confirm object, the continue download control and the cancel download control from the video playback page, and resuming displaying the download progress description object in the video playback page.

8. The method according to claim 1, wherein the resource is downloaded in the background in response to the trigger operation for the resource download control.

9. The method according to claim 1, wherein the method further comprises, before in response to determining that the resource has been completely downloaded, adding and displaying the second prompt object in the video playback page,
after switching the first video displayed in the video playback page to the second video, adding and displaying a background download confirm object in the video playback page, the background download confirm object being used to confirm whether to adjust to download the resource in the background; and
in response to a confirm background download operation triggered for the background download confirm object, canceling displaying the background download confirm object from the video playback page.

10. The method according to claim 9, wherein the method further comprises, after adding and displaying the background download confirm object in the video playback page,
in response to an abort background download operation triggered for the background download confirm object, canceling displaying the background download confirm object from the video playback page, and adding and displaying a third prompt object in the video playback page, the third prompt object being used to prompt that the downloading of the resource has been cancelled.

11. The method according to claim 1, wherein the second prompt object comprises a resource use control, the resource use control is used to trigger a use process for the resource that has been downloaded completely, and
the method further comprises, after adding and displaying the second prompt object in the video playback page,
in response to a video switch operation triggered for the video playback page, switching the second video displayed in the video playback page to a third video, and keeping displaying the second prompt object in the video playback page; and
in response to a trigger operation for the resource use control, canceling displaying the second prompt object from the video playback page.

12. An electronic device, comprising:
one or more processors;
a storage device for storing one or more programs,
the one or more programs, when executed by the one or more processors, cause the one or more processors to:
in response to a trigger operation for a resource download control displayed in a video playback page, add and display a download progress description object and a first prompt object in the video playback page, the resource download control being used to trigger a download process of a resource associated with a first video being displayed in the video playback page, the download progress description object being used to describe a download progress of the resource, and the first prompt object being used to prompt that switching a video does not interrupt the downloading of the resource; and
after switching the first video displayed in the video playback page to a second video, in response to determining that the resource has been completely downloaded, add and display a second prompt object in the video playback page, the second prompt object being used to prompt that the resource has been completely downloaded.

13. The device according to claim 12, wherein the video playback page is used to play a part or all of videos in a video stream in sequence; and
an arrangement position of the first video in the video stream is adjacent to an arrangement position of the second video in the video stream.

14. The device according to claim 12, wherein a position of the second prompt object in the video playback page and a position of the second video in the video playback page satisfy a preset position constraint, and the preset position constraint is used to ensure that an impact degree of displaying the second prompt object on displaying the second video does not exceed a preset threshold.

15. The device according to claim 12, wherein the first prompt object is displayed by covering the download progress description object; and
the one or more programs further cause the one or more processors to, after adding and displaying the download progress description object and the first prompt object in the video playback page:
in response to determining that a display duration of the first prompt object reaches a preset duration threshold or a close operation for the first prompt object being triggered, cancel displaying the first prompt object from the video playback page.

16. The device according to claim 12, wherein the display content of the download progress description object comprises a pause download identifier, and
the one or more programs further cause the one or more processors to, after adding and displaying the download progress description object and the first prompt object in the video playback page:
in response to a trigger operation for the download progress description object, cancel displaying the download progress description object from the video playback page, and add and display a continue download control and a cancel download control in the video playback page; and
in response to a trigger operation for the continue download control, cancel displaying the continue download control and the cancel download control from the video playback page, and resume displaying the download progress description object in the video playback page.

17. The device according to claim 16, wherein the one or more programs further cause the one or more processors to, after adding and displaying the continue download control and the cancel download control in the video playback page:
in response to a trigger operation for the cancel download control, add and display a cancel confirm object in the video playback page, the cancel confirm object being used to confirm whether to cancel the downloading of the resource;
in response to a confirm cancel operation triggered for the cancel confirm object, cancel displaying the cancel confirm object from the video playback page, and resume displaying the resource download control in the video playback page, and add and display a third prompt object in the video playback page, the third prompt object being used to prompt that the downloading of the resource has been cancelled; or
in response to an abort cancel operation triggered for the cancel confirm object, cancel displaying the cancel confirm object, the continue download control and the cancel download control from the video playback page, and resume displaying the download progress description object in the video playback page.

18. The device according to claim 12, wherein the one or more programs further cause the one or more processors to, before in response to determining that the resource has been completely downloaded, adding and displaying the second prompt object in the video playback page:
after switching the first video displayed in the video playback page to the second video, add and display a background download confirm object in the video playback page, the background download confirm object being used to confirm whether to adjust to download the resource in the background; and
in response to a confirm background download operation triggered for the background download confirm object, cancel displaying the background download confirm object from the video playback page.

19. The method according to claim 18, wherein the one or more programs further cause the one or more processors to, after adding and displaying the background download confirm object in the video playback page:
in response to an abort background download operation triggered for the background download confirm object, cancel displaying the background download confirm object from the video playback page, and add and display a third prompt object in the video playback page, the third prompt object being used to prompt that the downloading of the resource has been cancelled.

20. A non-transitory storage medium containing computer-executable instructions, wherein the computer-executable instructions, when executed by one or more computer processors, are used to cause the one or more computer processors to:
in response to a trigger operation for a resource download control displayed in a video playback page, add and display a download progress description object and a first prompt object in the video playback page, the resource download control being used to trigger a download process of a resource associated with a first video being displayed in the video playback page, the download progress description object being used to describe a download progress of the resource, and the first prompt object being used to prompt that switching a video does not interrupt the downloading of the resource; and
after switching the first video displayed in the video playback page to a second video, in response to determining that the resource has been completely downloaded, add and display a second prompt object in the video playback page, the second prompt object being used to prompt that the resource has been completely downloaded.
